(19) United States
(12) Patent Application Publication
(10) Pub. No.: US 2008/0298164 A1
(43) Pub. Date: Dec. 4, 2008

(54) Cordless Mixer

(76) Inventor: Ian Geoffrey Wilson, New South Wales (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/573,440

(22) PCT Filed: Jul. 21, 2005
(86) PCT No.: PCT/AU2005/001063

§ 371 Date: Aug. 20, 2008

(30) Foreign Application Priority Data
Aug. 9, 2004 (AU) 2004904425

(51) Int. Cl. B01F 15/00

(52) U.S. Cl. 366/129

(57) ABSTRACT

A cordless kitchen appliance (10) comprising a power unit (12), a detachable blade extension unit (14) and a base module (60); said power unit and said detachable extension unit adapted for retention in said base module when not in use; said detachable extension unit provided at a distal end with an open cage; said open cage (34) shrouding a blade assembly (52).

The present invention relates to appliances for the mixing and blending of ingredients and, more particularly to hand held cordless mixers,

### BACKGROUND

Handheld mixers, sometimes called “stick mixers”, are a popular kitchen appliance, being quick and easy to use, particularly for the mixing of drinks and other liquid ingredients, as well as for the chopping up of small quantities of nuts, making biscuit crumbs and the like.

A disadvantage of typical hand held mixers is the restrictions placed on their use through the connection of the power cord to a power outlet, forcing a user to operate the device in an area adjacent the outlet.

There is also a risk that the cord will catch on other articles and containers, causing these to spill or fall off a kitchen bench. The cord also is a nuisance for storage, likely to catch on other articles as it is extracted from a cupboard.

Furthermore there is usually no convenient way of storing the appliance when not in use. When used frequently, such as for drinks in households with young children, the length of the appliance and its attached cord make it an inconvenient item to be left readily accessible on a kitchen bench.

A more serious disadvantage is that hand held mixers operating from mains power, constitute an inherent danger to a user if not handled with care. The cord presents a danger if the mixer is used over a hot stove for the stirring of soup for example. When used to stir or blend ingredients in large containers there is a risk of electrocution if the mixer is accidentally dropped into the container. Furthermore, there is a tendency, even in those mixers which allow the blades to be removed for cleaning, to run the mixer in deeper washing up water, again with a serious risk of electrocution if the appliance is accidentally dropped.

These risks are of course accentuated when these appliances are used by children. In particular, stick mixers commonly employ a thin metal blade which can cause serious lacerations to curious fingers.

As well as constituting a safety issue, this type of blade is not well suited to certain blending and mixing applications, in particular the mixing of milk shakes and “smoothies” (milk-based drinks with fruit, usually a banana). These are typically prepared in relatively small quantities but the action of typically bladed stick mixers is so violent in a small container, as to risk ejecting the mixture.

There have been problems with developing cordless mixers which have sufficient on-board power to satisfactorily perform the functions for which such mixers are most often used, yet which are not so bulky or heavy as to make them awkward to use. High density batteries such as nickel metal hydride and the more recently developed lithium iron and lithium polymer batteries are not really suitable, since these appliances require a rapid discharge profile as well as a high energy density.

It is an object of the present invention to address or at least ameliorate some of the above disadvantages.

### BRIEF DESCRIPTION OF INVENTION

Accordingly, in a first broad form of the invention there is provided a cordless kitchen appliance. comprising a power unit, a detachable blade extension unit and a base module; said power unit and said detachable extension unit adapted for retention in said base module when not in use; said detachable extension unit provided at a distal, end with an open cage; said open cage shrouding a blade assembly.

Preferably, said power unit and said detachable extension unit when assembled together are adapted for mixing food ingredients by rotation of said blade assembly.

Preferably, said power unit comprises a body containing at least one power source and an electric motor.

Preferably, said body comprises a lower body portion adapted for grasping by the hand of a user, and an angled, rearwardly projecting upper body portion arranged to nestle against said hand grasping said lower body portion.

Preferably, at least one power source includes first and second rechargeable battery clusters.

Preferably, said first battery cluster is disposed within said lower body portion; and wherein said second battery cluster is disposed within, said upper body portion.

Preferably, said first and second rechargeable battery clusters are held in a supporting element arranged so as to allow said first and second battery clusters to be extracted from said power unit and inserted into said power unit as a single power module.

Preferably, each of said first and second battery clusters comprises AA size battery cells.

Preferably, said lower body portion is provided at a lower end with engagement mechanisms for releasable engagement to said detachable blade extension unit.

Preferably, said detachable blade extension unit comprises an attachment housing and an elongate hollow member enclosing a drive shaft; said attachment housing provided with an engagement mechanism for releasable attachment to said lower body portion at a proximate end and said open cage at a distal end.

Preferably, said drive shaft is adapted at said proximate end for engagement with an output shaft of said power unit.

Preferably, said open cage comprises struts spaced around said cage and a skirt; said struts extending from said distal end of said elongate member to a proximate edge of said skirt: said skirt comprising a ring element concentric with said drive shaft.

Preferably, said ring element is provided with crenellations at a distal edge of said skirt; said crenellations separated by downwardly projecting portions.

Preferably, spaces between said struts and openings formed by said crenellations allow flow of said food ingredients into and out of said open cage.

Preferably, said projecting portions are provided with sharpened edges adapted for cutting solid elements of said food ingredients.

Preferably, said blade assembly comprises at least one disc affixed to said drive shaft at said distal end.

Preferably, an axis of said at least one disc is coincident with an axis of said drive shaft.

Preferably, an axis of said at least one disc intersects an axis of said drive shaft at an angle.

Preferably, said disc with an axis at an angle to said axis of said drive shaft; and wherein said disc is placed at an outermost end of said shaft, said disc exerts compressive forces on liquid and solid constituents of said food mixture.

Preferably, said blade assembly comprises a pair of discs.

Preferably, a distal one of said pair of discs is provided with a projecting blade; said blade projecting at an angle normal to said disc.

Preferably, said blade assembly comprises one said disc and a tapering Archimedes screw.

Preferably, an axis of at least one disc of said pair of discs intersects an axis of said drive shaft at an angle.

Preferably, edges of any said disc are rounded so as to reduce risk of lacerations of fingers inadvertently brought into contact with said disc.

Preferably, edges of any said disc are rounded so as to substantially prevent splashing of said food ingredients.

Preferably, configuration of any said disc and said open cage is such as to prevent contact of said disc with surfaces of a container.

Preferably, said lower body portion is further provided at a lower end with electrical contacts; said electrical contacts connected to said first and said second rechargeable battery clusters.

Preferably, said electrical contacts comprise two conductive rings disposed one above the other around a cylindrical portion of said lower end of said lower body portion.

Preferably, an upper of said two conductive rings is larger in diameter than a lower one of said two conductive rings.

Preferably, said base module is comprised of a body arranged for support on a horizontal surface; said base module adapted for recharging of said power module.

Preferably, said body is provided with two side by side wells having substantially vertical axes; a first said well adapted to receive and support said power unit and a second said well adapted to receive said detachable blade extension unit.

Preferably, said first well is provided with electrical contacts adapted to connect with said electrical contacts of said power unit when said power unit is inserted into said first well; said electrical contacts of said first well forming rings so as to allow electrical conductivity between respective said contacts of said power unit and said first well regardless of angular orientation of said power unit in said first well.

In a further broad form of the invention there is provided a method for storage of a cordless handheld mixer; said method including the steps of;
a. providing said mixer in two portions comprising a power unit and a detachable blade extension unit, said power unit provided with two conductive rings,
b. providing a base module comprising a body with two well apertures; one of said well apertures provided with corresponding conductive rings,
c. separating said two portion of said mixer,
d. inserting said power unit in a first of said two well apertures such that said respective conductive rings of said power unit engage conductive rings of said well,
e. inserting said attachable blade extension unit in a second of said two well apertures.

Preferably, said base module is a recharging base module.

In yet a further broad form of the invention there is provided a cordless kitchen appliance comprising a power unit, a detachable extension unit and a base module; said power unit and said detachable extension unit adapted for retention in said base module when not in use.

Preferably, said power unit comprises a body containing at least one power source and an electric motor.

Preferably, said body comprises a lower body portion adapted for grasping by the hand of a user, and an angled, rearwardly projecting upper body portion arranged to nestle against said hand grasping said lower body portion.

Preferably, said at least one power source includes first and second rechargeable battery clusters.

Preferably, said first battery cluster is disposed within said lower body portion.

Preferably, said second battery cluster is disposed within said upper body portion.

Preferably, said first and second rechargeable battery clusters are held in a supporting element arranged so as to allow said first and second battery clusters to be extracted from said power unit and inserted into said power unit as a single power module.

Preferably, each of said first and second battery clusters comprises AA size battery cells.

Preferably, each said first and second battery cluster comprises four AA size battery cells.

Preferably, said first and second battery clusters comprise four and six AA size battery cells respectively.

Preferably, said power unit is provided with power control means.

Preferably, said power control means includes at least one power on/off switch.

Preferably, said power control means includes at least one speed control switch.

Preferably, said lower body portion is provided with a flexible portion disposed along a front portion of said body portion; said flexible portion overlying said power control means; said power control means adapted for manipulation by fingers of said hand through said flexible portion.

Preferably, said lower body portion is provided at a lower end with electrical contacts; said electrical contacts connected to said first and said second rechargeable battery clusters.

Preferably, said electrical contacts comprise two conductive rings disposed one above the other around a cylindrical portion of said lower end of said lower body portion.

Preferably, an upper of said two conductive rings is larger in diameter than a lower one of said two conductive rings.

Preferably, said lower body portion is further provided at said lower end with engagement mechanisms for releasable engagement with said detachable blade extension unit.

Preferably, said extension unit is adapted for mixing liquid ingredients by rotation of an agitator element.

Preferably, said agitator element comprises at least one blade affixed to a drive shaft rotatably mounted in said extension unit.

Preferably, said extension unit comprises a elongate hollow member enclosing said drive shaft and a bell housing at a distal end of said hollow member; said at least one blade disposed substantially within said bell housing.

Preferably, said elongate hollow member is provided at a proximate end, with a connector portion adapted for releasable engagement with said lower body portion.

Preferably, said bell housing is open at a lower wide end; said lower wide end provided with openings arranged so as to allow passage of liquids therethrough.

Preferably, said drive shaft is mounted in a bearing within said distal end of said extension unit.

Preferably, said drive shaft is arranged at said proximate end for engagement with an output shaft of said power unit.

Preferably, said base module is comprised of a body arranged for support on a horizontal surface; said base module adapted for recharging of said at least one power source.

Preferably, said body is provided with two side by side wells having substantially vertical axes; a first said well adapted to receive and support said power unit and a second said well adapted to receive said attachable extension unit.

Preferably, said first well is provided with electrical contacts adapted to connect with said electrical contacts of said power unit when said power unit is inserted into said first well.

Preferably, said base module is provided with an electrical socket adapted to receive a power supply cord; said socket linked to said electrical contacts in said first well.

Preferably, direct current power is supplied to said base module from a transformer unit powered from a mains power supply.

Preferably, said base nodule is provided with a battery charging unit; said battery charging unit arranged to accept mains power as input.

Preferably, said base module is provided with a battery charge indicating light.

In yet a further broad form of the invention there is provided a power unit for a cordless handheld mixer; said power unit comprising an enclosure containing an electric motor, at least one rechargeable power source and a power control system.

Preferably, said enclosure comprises a lower body portion and an upper portion projecting at an angle from said lower body portion.

Preferably, said at least one rechargeable power source includes a first battery cluster disposed within said lower body portion.

Preferably, said at least one rechargeable power source includes a second battery cluster disposed within said upper portion.

Preferably, said power control system includes an on/off switch.

Preferably, said power control system includes a speed control switch.

Preferably, said on/off switch and said speed control switch are mounted within said lower body behind a portion of said body formed of a flexible material such that said on/off switch and said speed control switch may be operated by pressure applied with the fingers of a hand grasping said power unit.

In still a further broad form of the invention there is provided a An open cage shrouding a blade assembly for a food ingredient mixer; said open cage comprising struts spaced around said cage and a skirt; said struts extending from a distal end of a blade extension member to a proximate edge of said skirt; said skirt comprising a ring element concentric with a drive shaft of said mixer.

Preferably, said ring element is provided with crenellations at a distal edge of said skirt; said crenellations separated by downwardly projecting portions.

Preferably, spaces between said struts and openings formed by said crenellations allow flow of said food ingredients into and out of said open cage.

### BRIEF DESCRIPTION OF DRAWINGS

Embodiments of the present invention will now be described with reference to the accompanying drawings wherein:

FIG. 1 is a perspective view of a cordless mixer assembly comprising a power unit and a blade extension unit according to a first preferred embodiment of the invention,

FIG. 2 is a sectioned view of the cordless mixer assembly of FIG. 1

FIG. 3 is a perspective view of the power unit disassembled from the cordless mixer assembly of FIG. 1,

FIG. 4 is a perspective view of the cordless mixer of FIGS. 1 and 2, disassembled and placed in a base module,

FIG. 5 is a side elevation view of the mixer components and a mixing jug for use with said mixer.

FIG. 6 is a perspective view of the lower end of a further preferred embodiment of a blade extension unit.

FIGS. 7, to 10 are detailed views of blade configurations for use in the blade extension unit of FIG. 6.

### DETAILED DESCRIPTION OF PREFERRED EMBODIMENTS

### First Preferred Embodiment

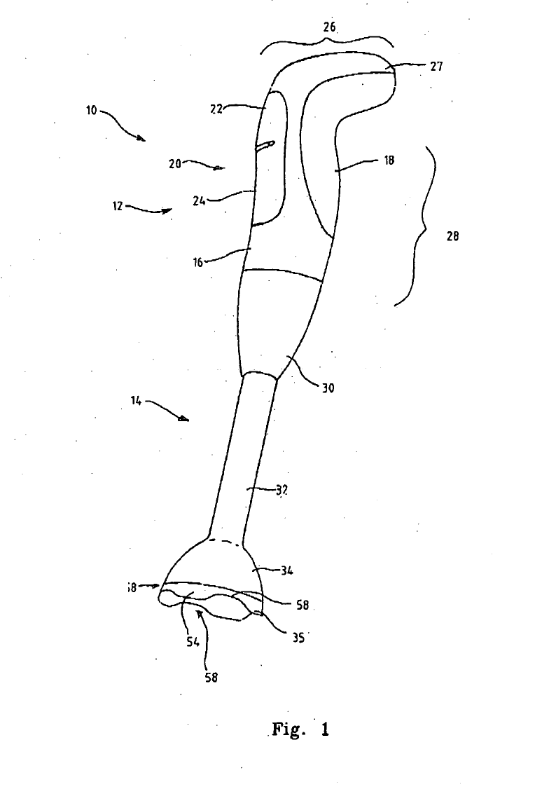

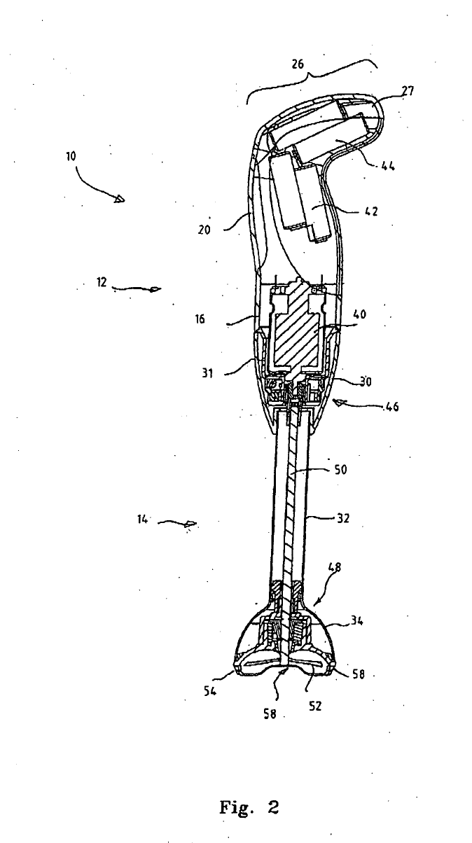

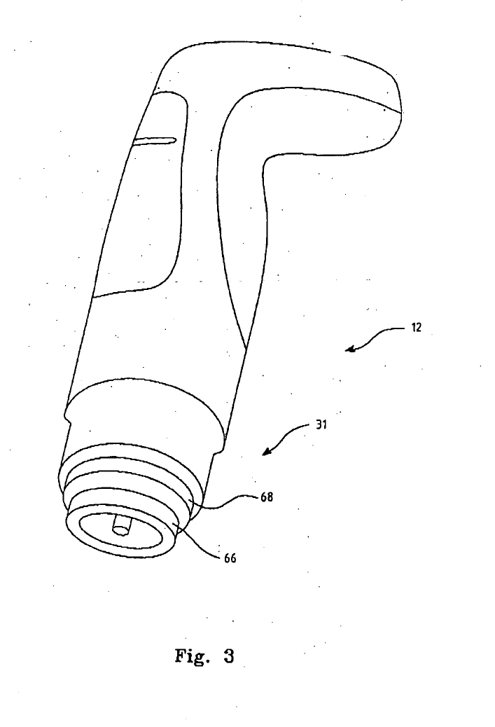

With reference to FIGS. 1 and 2, a cordless mixer 10 according to a first preferred embodiment of the invention comprises a power unit 12 releasably attached to a blade extension unit 14.

Power unit 12 comprises a body formed of a suitable high impact injection moulded plastic provided with a soft grip portion 18 and, in at least one preferred embodiment, a flexible control pad portion 20 at the front of power unit 12. Control pad portion 12 is preferably divided into two zones so that an upper portion 22 is adapted to control an on/off switch and the lower portion 24 is adapted to control a variable speed switch. Both switches (not shown) are arranged behind the flexible control pad portion 20 so that they may be manipulated through the flexible pad by the fingers of a grasping hand (not shown). Alternatively, control of power unit 12 may be provided by suitable switches mounted in the surface of the front of lower body portion 28.

The upper part of power unit 12 is formed with a projecting upper body portion 26 extending rearwardly and, preferably, at an angle from lower body portion 28, shaped so that the underside of the upper body portion nestles comfortably against a hand of a user, thereby helping to securely support the mixer in use.

As can be seen in FIG. 2, power unit 12 includes a drive motor 40 and first and second battery clusters 42 and 44. By splitting the battery capacity into two sections in this way, sufficient power capacity can be provided without the power unit becoming awkwardly large either in girth or in length. Battery power may by means of this configuration, be supplied by standard conventional and economical rechargeable nickel cadmium cells.

In preferred embodiments of the invention, the cells may either be eight AA size cells to deliver 9.6V or ten AA cells for 12V. For a 9.6V system each battery cluster 42 and 44 comprise four cells, while for the 12V system, battery cluster 44 comprises six cells. For this version the cap 27 of upper portion 26 may be somewhat higher to accommodate the larger number of cells. Cap 27 is arranged so as to be removable from upper body portion 26 to allow for the replacement of the battery clusters should this become necessary. Preferably, the two clusters may be arranged in a holding rack providing electrical contact between the two clusters and allowing the clusters to be inserted and extracted as a single power module.

Blade extension unit 14 comprises an attachment housing 30, an elongate hollow member 32 and a blade assembly housing 34. Attachment housing 30 is attached to power unit 12 by any suitable means such as for example catch mechanisms adapted to engage with detents provided in a projecting cylindrical portion 31 of the power unit 12, or a bayonet type of arrangement (not shown). Preferably, attachment housing 30 is made of the same impact resistant plastic as that used for power unit 12.

As can be seen in FIG. 2, attachment housing 30 is provided with a lower shaft bearing 48. Bearing 48 supports drive shaft 50, which carries a typical mixer blade 52 at its lower end. Drive shaft 50 engages with the output shaft of motor 40 at its upper end.

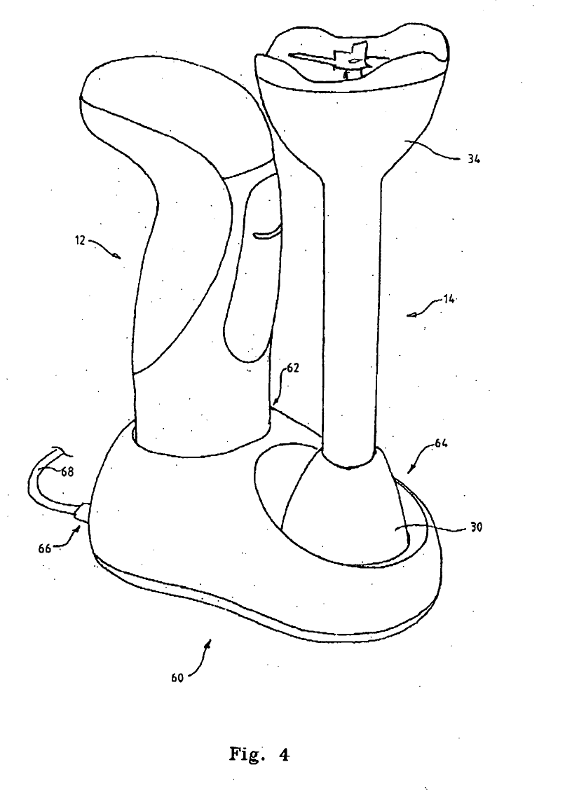

With reference now to FIGS. 3 and 4, power unit 12 and blade extension unit 14, when separated, may be stored in a flat bottomed base module 60 adapted for support on a horizontal surface such as a bench top or cupboard shelf. Base module 60 is provided with a power unit well 62 and a blade extension unit well 64. Each well is arranged with its axis substantially vertical so as to maintain power unit 12 and extension unit 14 in vertical positions when inserted. Power unit well 62 is provided with positive and negative electrical contacts (not visible) arranged to engage with respective conductive rings 66 and 68 arranged at the end of cylindrical portion 31 of power unit 12. Lower ring 66 is of a smaller diameter than upper ring 68. Conductive rings 66 and 68 in turn are connected to the battery clusters 42 and 44.

The electrical contacts in power unit well 62 are connected to a power socket 67 at the rear of base module 60, adapted to receive a power cord 69. Power cord 69 is provided with direct current from a suitable transformer (not shown) connected to a mains power outlet. Alternatively, in at least one preferred embodiment, the transformer is built into the base module 60.

Blade extension unit 14 is maintained in well 64 in a vertical position by sliding over a central upwardly projecting boss (not visible) of similar configuration as the cylindrical portion 31 of power unit 12.

### Second Preferred Embodiment

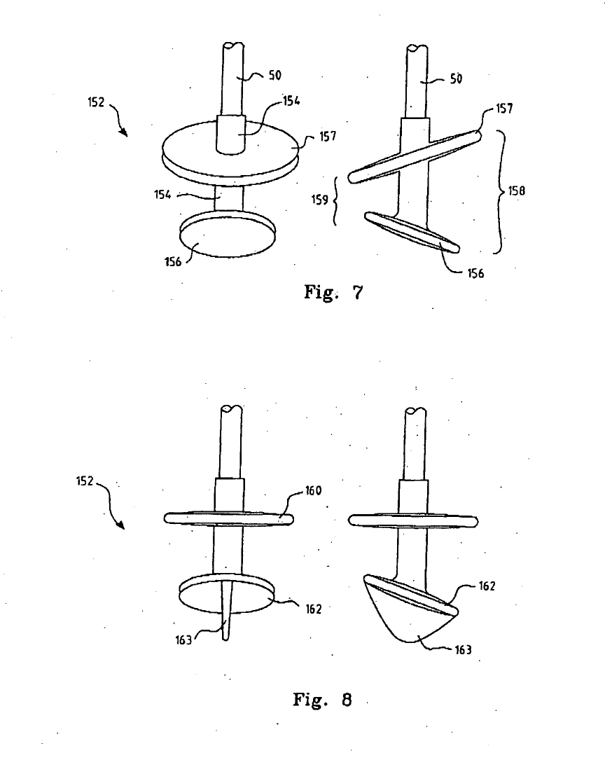

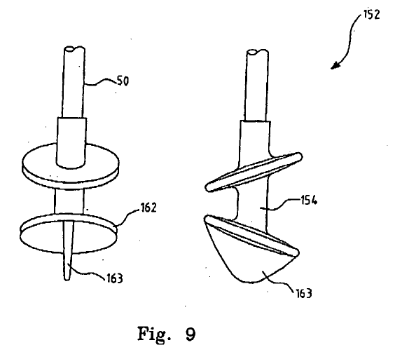

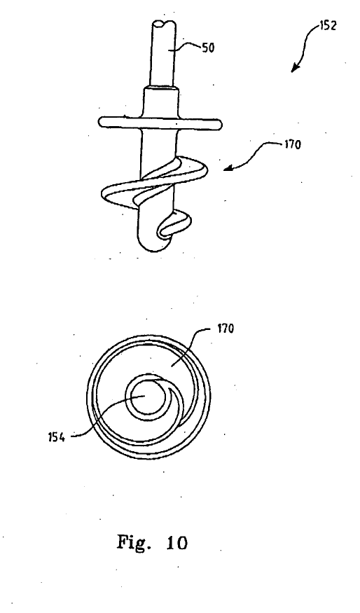

With reference now to FIGS. 6, in a particularly preferred embodiment of the invention, the blade extension unit 14 is provided at its distal end with a protective open cage 134 formed of struts 136 and skirt 138. A blade assembly 152 is attached to the end of drive shaft 50 and is adapted to rotate within the confines of open cage 134. Blade assembly 152 may take a number of forms as shown in FIGS. 7 to 10, but includes a central shaft 154 and at least one angled disc element 156.

Skirt 138 is formed with downwardly projecting elements 139, leaving between them raised arches or crenellations 140 such that when the mixer is resting on, or is pushed vertically down onto the bottom of a container, fluids may pass under arches 140, as well as through openings 137 between struts 136. Preferably, downwardly projecting elements 139 are formed with relatively sharp edges 142 which can assist in breaking up lumps of material, such as for example pieces of banana or other fruit, to assist in the mixing action, of the blade assembly.

Cage 134 and blade assembly 152 are configured so as to leave reasonable clearance between the periphery of the rotating discs of the assembly and the struts of the cage. This, together with the general bell shape of the cage, allows a user to bring the mixing action close to the sides of a container but precludes contact between the blade assembly and the container.

Blade assembly 152 is preferably formed of a relatively flexible plastic and with rounded edges so that the risk of laceration of fingers inadvertently inserted is at least reduced.

In those preferred embodiments of the blade assembly, discussed in more detail below, which have a lower angled disc element, that element rotates in close proximity to the level of the downwardly projecting elements 139. Thus when the mixer is in contact with the bottom of a container, the disc element continually compresses liquid and solid elements of the mixture between the bottom and the disc.

In a first preferred configuration of blade assembly 152 shown in FIG. 7, the assembly includes two oppositely angled discs integrally moulded to shaft 154, a lower disc 156 and upper disc 157. As the discs rotate through a mixture, fresh portions are drawn in between the widely separated regions of the discs 158, compressed and ejected from between the narrowing regions 159.

In a second preferred embodiment of the blade assembly 152 shown in FIG. 8, the axis of the upper disc 160 is coincident with the axis of shaft 154. In this embodiment the lower angled disc 162 is provided with a mixing blade 163 projecting from the underside of the disc. This blade rotates in close proximity to the bottom of a container when the skirt 138 is in contact with the bottom and is particularly useful in the mixing of heavier ingredients.

In a third preferred configuration of the blade assembly 152 shown in FIG. 9, both the upper and lower discs are oppositely angled and the lower disc provided with a mixing blade as previously described.

In a fourth preferred configuration of the blade assembly as shown in FIG. 10, the assembly comprises a single upper disc with its axis coincident with the axis of shaft 154. A tapering Archimedes screw is provided for a portion of the lower end of shaft 154. During rotation of blade assembly 152, the screw drives mix ingredients firstly downward and then outward.

### In Use

When the cordless mixer of the present invention has been charged in the base module, the power unit is attached to the extension unit.

After use, the extension unit may be detached from the power unit and the power unit placed into its well in the base module. The battery clusters of power unit 12 are then recharged and maintained inca charged condition while ever the power unit is so stored in the base module and the module connected to a power source. After washing, the extension unit is also placed in the base module, the arrangement providing convenient bench top storage while not in use.

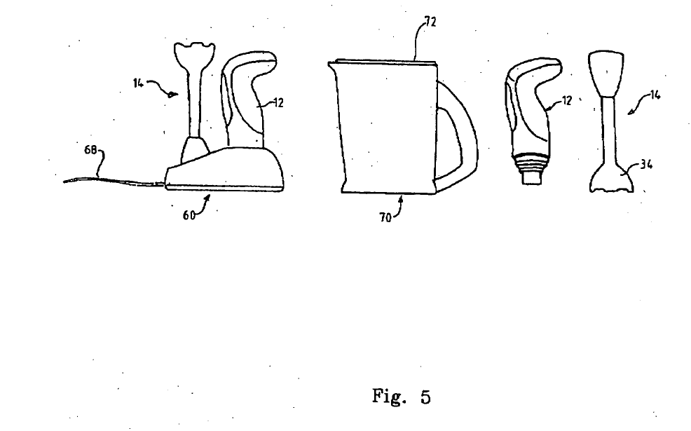

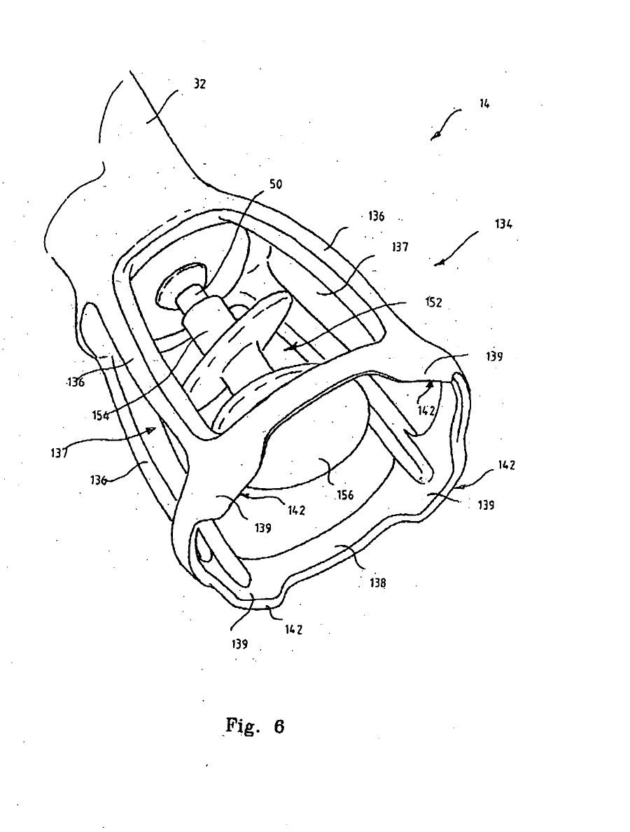

The mixer of the present invention may be supplied with auxiliary equipment such as for example a mixing jug 70 as shown in FIG. 5. Jug 70 is provided with a splash guard lid 72. In at least one preferred embodiment of the invention, lid 72 may be adapted to support the mixer assembly in a vertical position within the jug so that the skirt 35 of bell housing 34, or the skirt 138 of open cage 134 is in light contact with the base of the jug.

The above describes only some embodiments of the present invention and modifications, obvious to those skilled in the art, can be made thereto without departing from the scope and spirit of the present invention. Thus although the description of the preferred embodiment of the invention is with reference to a mixer for liquid ingredients, the principles of a cordless power unit and a detachable extension which may be supported in a base module, may also be applied to other kitchen appliances, such as an electric knife for example.

What is claimed is:

1-77. (canceled)

78. A cordless kitchen appliance commonly known as a “stick mixer” for the mixing of liquids and other food ingredients; said mixer comprising a power unit and a blade extension unit; said power unit adapted to accommodate first and second power sources; wherein said power unit is formed with a projecting upper body portion extending from a lower portion of said power unit; said first power source being disposed within said lower body portion; and wherein said second power source is disposed within said upper body portion.

79. The appliance of claim 78 wherein said lower body portion is shaped for grasping by the hand of a user, and said projecting upper body portion is angled relative said lower body portion; said upper body portion arranged to nestle against said hand grasping said lower body portion.

80. The appliance of claim 78 wherein said first and second power sources comprise first and second battery clusters.

81. The appliance of claim 80 wherein each of said first and second battery clusters comprises AA size battery cells.

82. The appliance of claim 81 wherein said battery cells are rechargeable battery cells.

83. The appliance of claim 80 wherein each of said first and second battery clusters comprises four AA size battery cells.

84. The appliance of claim 80 wherein said first and second battery clusters comprise four and six AA size battery cells respectively.

85. The appliance of claim 78 wherein said power unit is detachable from said blade extension unit.

86. The appliance of claim 78 wherein said power unit is provided with an on/off switch and a speed control switch.

87. The appliance of claim 86 wherein said on/off switch and said speed control switch are mounted within said lower body portion behind a portion of said body formed of a flexible material such that said on/off switch and said speed control switch may be operated by pressure applied with the fingers of said hand grasping said lower body portion.

88. An open cage and blade assembly of a cordless “stick mixer” kitchen appliance for mixing food ingredients; said open cage comprising struts spaced around said cage and a skirt; said struts extending from a distal end of a mixer blade extension unit to a proximate edge of said skirt; said skirt comprising a ring element concentric with a drive shaft of said mixer; said blade assembly including at least one angled disc.

89. The cage and blade assembly of claim 88 wherein said ring element is provided with raised arches or crenellations at a distal edge of said skirt; said crenellations separated by downwardly projecting portions.

90. The cage and blade assembly of claim 88 wherein spaces between said struts and spaces formed by said crenellations allow flow of said food ingredients into and out of said open cage.

91. The cage and blade assembly of claim 89 wherein said projecting portions are provided with sharpened edges adapted for cutting solid elements of said food ingredients.

92. The cage and blade assembly of claim 88 wherein said at least one angled disc is affixed to a distal end of said drive shaft; said disc proximate to a plane defined by edges of said projecting portions.

93. The cage and blade assembly of claim 88 wherein an axis of said at least one angled disc intersects an axis of said drive shaft at an angle.

94. The cage and blade assembly of claim 88 wherein said at least one angled disc rotates proximate a surface of a container when said downward projecting portions are in contact with said surface; rotation of said disc exerting compressive forces on liquid and solid constituents of said food mixture between said disc and said surface .

95. The cage and blade assembly of claim 88 wherein said blade extension unit is releasably attached to a power unit; said power unit including first and second battery power sources.

96. The cage and blade assembly of claim 88 wherein said drive shaft is adapted at said proximate end for engagement with an output shaft of said power unit.

97. The cage and blade assembly of claim 95 wherein said first and second battery power sources comprise first and second battery clusters of rechargeable AA size battery cells.

98. The cage and blade assembly of claim 95 wherein said power unit is formed with a projecting upper body portion extending from a lower portion of said power unit; said first battery power source being disposed within said lower body portion; and wherein said second battery power source is disposed within said upper body portion.

99. The cage and blade assembly of claim 98 wherein said lower body portion is shaped for grasping by the hand of a user, and said projecting upper body portion is angled relative said lower body portion; said upper body portion arranged to nestle against said hand grasping said lower body portion.
